(19) United States
(12) Patent Application Publication
(10) Pub. No.: US 2004/0119218 A1
(43) Pub. Date: Jun. 24, 2004

(54) Spring seat and spring assembly

(75) Inventors: Hideyuki Imanaka, Osaka (JP); Hideki Hashimoto, Osaka (JP); Keisuke Fujioka, Canton, MI (US)

Correspondence Address: SHINJYU GLOBAL IP COUNSELORS, LLP, 1233 20TH STREET, NW, SUITE 700, WASHINGTON, DC, 20036-2680, US

(73) Assignee: Exedy Corporation

(21) Appl. No.: 10/726,499

(22) Filed: Dec. 4, 2003

(30) Foreign Application Priority Data
Dec. 6, 2002 (JP) 2002-355191

(51) Int. Cl. F16F 1/04

(52) U.S. Cl. 267/286

(57) ABSTRACT

A spring seat is disclosed which is employed on a spring that serves to absorb and attenuate torsional vibrations. The spring seat includes a seat body that serves to support an end portion of the spring, and a sliding portion that is fixed to an outer side of the seat body and composed of a material that is different from that of the seat body.

### BACKGROUND OF THE INVENTION

1. Field of the Invention

The present invention relates to a spring seat, and more particularly to a spring seat for supporting a spring that absorbs and dampens torsional vibrations.

2. Background Information

Spring members such as coil springs or the like are employed in the damper mechanism found in vehicle clutch assemblies, flywheel assemblies, lock-up clutches in torque converters, and the like, and serve to absorb and dampen torsional vibrations.

The coil springs are disposed such that they extend lengthwise in the rotational direction inside windows formed in two input side rotation members and one output side rotation member. Both ends in the rotational direction of each coil spring are supported by the edges of the windows in the circumferential direction, and each coil spring is also supported by the windows in both the radial and axial directions. Thus, when the input side rotation members and the output side rotation member rotate with respect to each other, the coil springs are compressed between the edges on one side of the windows in the rotational direction and the edges on the other side of the windows in the rotational direction.

In addition, a spring seat is sometimes disposed on each end of each coil spring. A spring seat is disposed on the ends of each coil spring, and contacts with the edges of the windows in the rotational direction. Each spring seat includes, for example, a body portion that contacts with a seat surface of the coil spring, a projecting portion that extends from the body portion into the interior of the coil spring, and cover portions that extend from the body portion and cover the outer sides of an end portion of the coil spring.

With the aforementioned spring seats, the coil springs move peripherally outward due to centrifugal force when compressed by torsional vibrations, and the cover portions of the spring seats slide on the outer edges of the windows in each rotational member. The amount of noise and vibrations produced by the damper mechanism will decline due to this sliding. This is because a reduced amount of frictional resistance with respect to very small torsional vibrations generated when an engine is operating in a normal RPM range will have a large effect on vibration dampening.

On the other hand, a standard spring seat is made of a metal so that it will maintain its strength with respect to the load placed on it by a spring. Because of that, it is difficult to reduce the sliding resistance between standard spring seats and other members of the damper mechanism.

In view of the above, there exists a need for a spring seat and a spring assembly which overcomes the above mentioned problems in the prior art. This invention addresses this need in the prior art as well as other needs, which will become apparent to those skilled in the art from this disclosure.

### SUMMARY OF THE INVENTION

An object of the present invention is to both maintain the strength and reduce the sliding resistance of a spring seat employed on a spring that serves to absorb and dampen torsional vibrations.

A spring seat according to a first aspect of the present invention serves to support a spring that absorbs and dampens torsional vibrations, and is comprised of a seat body that serves to support an end portion of the spring in the direction in which the spring is compressed, and a sliding portion that is composed of a material that is different from that of the seat body and which is capable of sliding on other members.

With this spring seat, the seat body and the sliding portion are made of different materials, and thus materials suitable for use with each of these portions can be selected.

According to a second aspect of the present invention, the spring seat is further comprised of cover portions that extend from the seat body and cover the outer sides of the spring. The sliding portion is mounted on the outer side of one of the cover portions.

With this spring seat, the sliding portion slides primarily with respect to other members because the sliding portion is mounted on the outer side of one of the cover portions.

According to a third aspect of the present invention, the seat body is composed of a material having a high degree of strength, and the sliding portion is composed of a material having a low coefficient of friction.

With this spring seat, a high degree of strength can be maintained with respect to the spring load because the seat body is composed of a material having a high degree of strength. In addition, the sliding resistance can be reduced because the sliding portion is composed of a material having a low coefficient of friction.

According to a fourth aspect of the present invention, the seat body is made of a metal, and the sliding portion is made of a synthetic resin.

According to a fifth aspect of the present invention, a spring assembly is comprised of a spring, and spring seats according to any of the first to fourth aspects of the present invention that are disposed on the end portions of the spring.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 shows a partial vertical cross section of a clutch disk assembly to which an embodiment of the present invention is applied;

FIG. 2 shows a plan view of a clutch disk assembly to which an embodiment of the present invention is applied; and

FIG. 3 shows a enlarged portion of a spring assembly shown in FIG. 2.

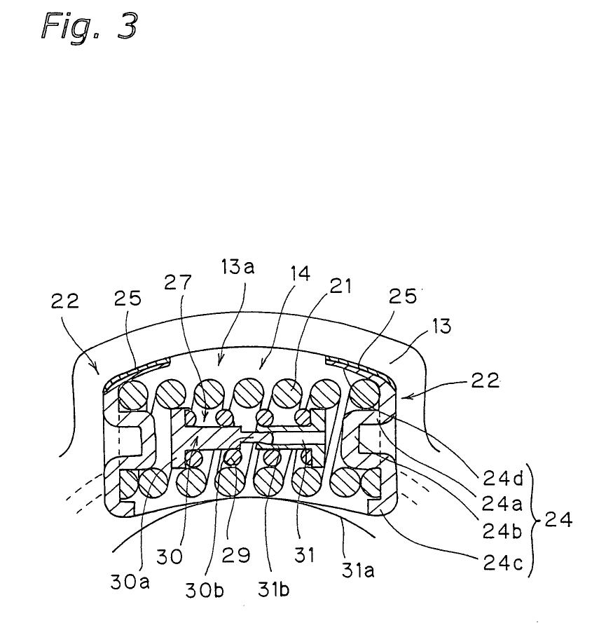

### DETAILED DESCRIPTION OF THE PREFERRED EMBODIMENTS

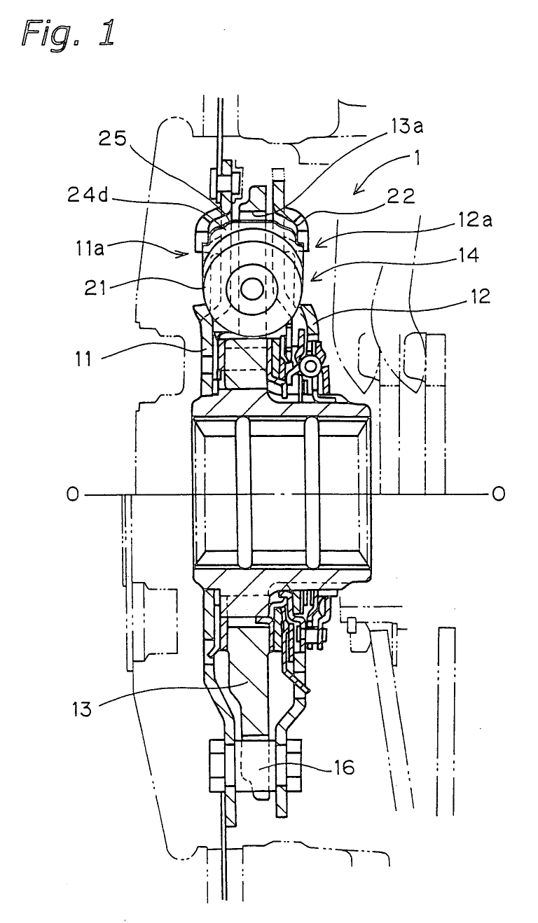

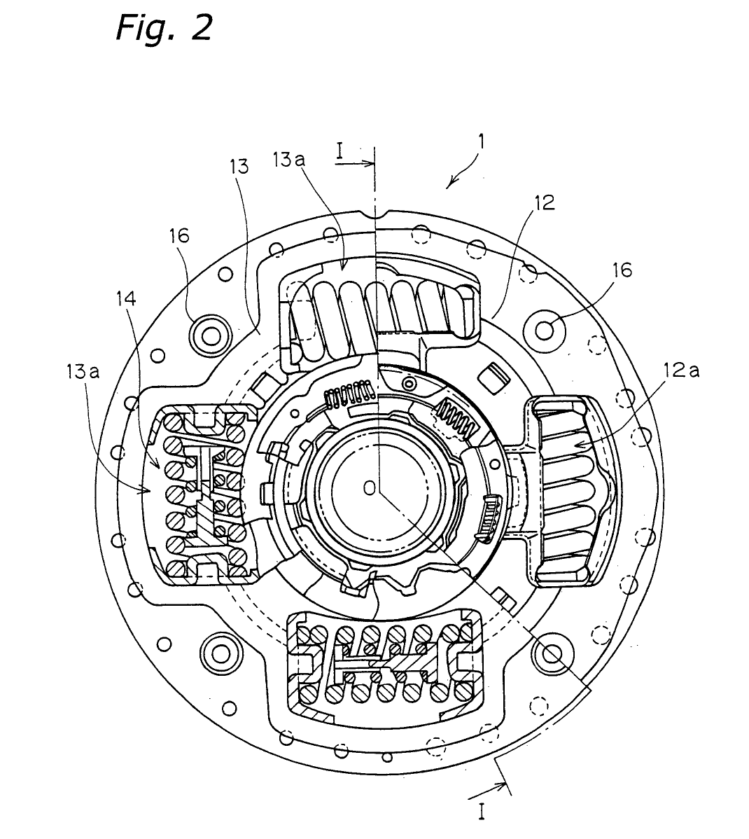

FIGS. 1 and 2 show a clutch disk assembly 1 that employs an embodiment of the present invention. The clutch disk assembly 1 primarily includes a clutch mechanism and a damper mechanism, but here only a description of the damper mechanism will be provided.

The clutch disk assembly 1 is primarily comprised of a pair of input side plates comprised of a clutch plate 11 and a leading plate 12, a hub flange 13, and spring assemblies 14 that links these elements together in the rotational direction.

The clutch plate 11 and the leading plate 12 are approximately disk-shaped members, and face each other across a predetermined gap in the axial direction. The plates 11, 12 are fixed to each other on their outer peripheral portions by means of a plurality of stopper pins 16, thus allowing both plates 11, 12 to rotate unitarily with each other. A plurality of (four) windows 11a, 12a are respectively formed in each plate 11, 12 and arranged in the circumferential direction. The windows 11a, 12a are hole members that are comparatively elongated and extend in the circumferential direction.

The hub flange 13 is an approximately disk-shaped member that is disposed in between the plates 11, 12 in the axial direction and which is capable of relative rotation therewith. A plurality of window holes 13a are formed in the hub flange 13 in positions corresponding to the windows 11a, 12a in the plates 11, 12. The window holes 13a are hole members that extend in the circumferential direction and are comparatively elongated, and have shapes that correspond to the windows 11a, 12a.

The spring assemblies 14 are comprised of members that serve to elastically couple the plates 11, 12 and the hub flange 13 in the rotational direction, and are respectively disposed in the windows 11a, 12a and window holes 13a. Each spring assembly 14 is primarily composed of a coil spring 21 and a pair of spring seats 22. Each coil spring 21 is a member that serves to absorb and dampen torsional vibrations in the damper mechanism, and extends in the circumferential direction. One spring seat 22 is disposed on each end of each coil spring 21, and each spring seat 22 is in contact with each circumferential end portion of the windows 11a, 12a and window holes 13a.

Each spring seat 22 is comprised of a seat body 24 and an outer peripheral sliding portion 25. The seat bodies 24 serve to receive torque from the coil springs 21, and are preferably composed of a material having a high degree of strength such as a metal or the like. Each seat body 24 is comprised of a support portion 24a that receives an end portion of the coil spring 21, a projecting portion 24b that extends from the center of the support portion 24a into the interior of the coil spring 21, a first cover portion 24c that covers the inner side (in the radial direction of the damper) of one end of the coil spring 21, and a second cover portion 24d that covers the outer side (in the radial direction of the damper) of one end of the coil spring 21. The first cover portion 24c is only long enough to cover an end turn portion of the coil spring 21, however the second cover portion 24d extends further than the first cover portion 24c and the tip thereof is disposed adjacent to the second coil from the end of the coil 30 spring 21. Each cover portion 24c, 24d functions to cover and support the side portions of the coil spring 21.

The outer peripheral sliding portion 25 of each spring seat 22 is mounted on the outer side of the seat body 24 in the radial direction of the damper, and serves to reduce sliding resistance with the window holes 13a and the like. More specifically, the outer peripheral sliding portion 25 is a thin layer that is fixed to the outer side of the second cover portion 24d of the seat body 24 in the radial direction of the damper. The outer peripheral sliding portion 25 is composed of a material that is different from that of the seat body 24, and more specifically is composed of material whose coefficient of friction is lower than that of the seat body 24. Even more specifically, the outer peripheral sliding portion 25 is composed of a material made of a synthetic resin such as PA66 Nylon or the like. Each outer peripheral sliding portion 25 is either adjacent to or in contact with the outer peripheral edges of each window hole 13a or the outer peripheral edges of the windows 11a, 12a. Note that each outer peripheral sliding portion 25 is molded with, adhered to, or inserted into each seat body 24 so that the two members are integral with each other.

Each spring assembly 14 also includes a float body 27. The float body 27 serves to effectuate stop torque in the damper mechanism. Each float body 27 is disposed inside each coil spring 21, and is capable of moving in the circumferential direction in between the projecting portions 24b of the spring seats 22. Each float body 27 is comprised of a small coil spring 29 and a pair of spring seats 30, 31. The pair of spring seats 30, 31 each include support portions 30a, 31a that support both ends of the small coil spring 29, and insertion engagement portions 30b, 31b that extend from the support portions 30a, 31a inside the small coil springs 29 which can move in the circumferential direction within a predetermined range to engage with each other.

When torque fluctuations from the engine are input to the clutch disk assembly 1, the plates 11, 12 rotate relative to the hub flange 13, and the coil springs are compressed therebetween. When this occurs, the spring assemblies 14 move peripherally outward due to centrifugal force and slide on the outer peripheral edges of the windows 11a, 12a and the window holes 13a. However, a large sliding resistance will not be generated because the outer peripheral sliding portions 25 on the spring seats 22 will slide on the other members. In other words, the friction on the spring seats 22 will be reduced, and thus the life of the spring seats 22 will be extended. Moreover, the noise and vibration performance of the damper mechanism will be improved because the sliding resistance between the spring seats 22 and other members will be reduced. This is because a reduced amount of frictional resistance with respect to very small torsional vibrations generated when an engine is operating in a normal RPM range will have a vibration dampening effect.

As noted above, the materials that form the seat bodies 24 and the outer peripheral sliding portions 25 of the spring seats 22 are different from each other.

The present invention is not limited to the embodiment described above. For example, the shape and/or the structure of the spring seat may be different from that described in the aforementioned embodiment. In addition, the material that forms the outer peripheral sliding portions 25 is not limited to a synthetic resin, and may instead be a solid lubricant such as graphite or molybdenum disulfide.

With the spring seats according to the present invention, the seat bodies and the sliding members are made of different materials, and thus materials suitable for each of these members can be selected. In particular, when the seat bodies are formed from a material having a high degree of strength and the sliding members are formed from a material having a low coefficient of friction, the ability of the clutch disk assembly to transmit torque will be maintained at a sufficient level and the sliding resistance therein will be reduced.

This application claims priority to Japanese Patent Application No. 2002-355191. The entire disclosure of Japanese Patent Application No. 2002-355191 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A spring seat for supporting a spring that absorbs and dampens torsional vibrations, the spring seat comprising:
a seat body that supports an end portion of the spring in a direction in which the spring is compressed; and
a sliding portion comprised of a material that is different from a material that the seat body is comprised of and capable of sliding on other members.

2. The spring seat set forth in claim 1, further comprising:
cover portions that extend from the seat body and which cover outer sides of the spring;
wherein the sliding portion is mounted on an outer side of one of the cover portions.

3. The spring seat set forth in claim 1, wherein the seat body is comprised of a material having a high degree of strength, and the sliding portion is comprised of a material having a low coefficient of friction.

4. The spring seat set forth in claim 3, wherein the seat body is made of a metal, and the sliding portion is made of a synthetic resin.

5. A spring assembly, comprising:
a spring; and
a spring sheet set forth in claim 1 and mounted on the end portion of the spring.
